(19) United States
(12) Patent Application Publication
(10) Pub. No.: US 2012/0000431 A1
(43) Pub. Date: Jan. 5, 2012

(54) Electronic Pet Containment System

(76) Inventor: Kamran Khoshkish, Tehran (IR)

(21) Appl. No.: 13/007,806

(22) Filed: Jan. 17, 2011

Related U.S. Application Data
(60) Provisional application No. 61/361,457, filed on Jul. 5, 2010.

(51) Int. Cl. A01K 15/04

(52) U.S. Cl. 119/720; 119/721

(57) ABSTRACT

The present invention relates to an electronic containment system including one or more site units and one or more pet units. The site unit couples to a geographic site, while the pet unit is worn by a pet. Each unit includes a transceiver, and may be paired such that a unit connected to a facility or site selectively activates an alarm on the pet unit to direct the pet away from the facility. Specifically, a user enters user-defined parameters such as pet identification, permitted access level, and type of notification. A first pet unit may be programmed to permit a first pet access to the site, while a second pet unit may be programmed to deny a second pet access to the site.

### CROSS REFERENCE TO RELATED APPLICATIONS

The present application is a nonprovisional of U.S. provisional application 61/361,457, filed 5 Jul. 2010 and entitled “Electronic Pet Containment System,” the disclosure of which is hereby incorporated by reference in its entirety.

### FIELD OF THE INVENTION

The present invention relates to an electronic containment system and, in particular, to a pet control system that selectively permits or denies pet access to preselected sites within a location.

### BACKGROUND OF THE INVENTION

Conventional electronic animal containment systems are designed to prevent an animal or pet from escaping from a defined boundary. These systems, such as electronic fences, enable a user to design and control an electronic boundary. The electronic boundary acts like an antenna, picking up signals from a transmitter and sending them to the pet's receiver/collar. When the pet approaches the boundary, a warning signal is generated. If the pet moves beyond the defined boundary, the pet receives a static shock. In this manner, the collar encourages or discourages the behavior of the pet, keeping the pet within the defined boundary.

Typical electronic animal containment systems are subterranean, involving a buried antenna that requires excavation of the confinement area, which can damage surrounding grass and flowerbeds. These systems, moreover, are generally permanent since the fixed location of the buried antenna prohibits easy alteration and redefinition of the confinement area. Any change in animal location typically necessitates re-installment of all or part of the containment system. These systems, moreover, cannot differentiate between pets, selectively permitting pets to travel within and beyond the defined boundary.

It would be desirable to provide an electronic containment system that is easily portable, can be customized, and that is capable of monitoring and controlling an animal's access to sites within a location.

### SUMMARY OF THE INVENTION

The present invention relates to an electronic containment system including a series of transmitter/receiver (transceiver) units that are selectively paired to permit a desired level of access to sites within a control area. The transceiver units include a central processor, a communications or transceiver module, a distance detection module, and an optional pairing module. The communications module communicates with (i.e., transfers data between) other transceiver units within the system. The central processor utilizes the data to identify units within the system and to recognize whether a first transceiver unit is paired with another transceiver unit. The pairing module electronically links specified units to permit the transfer of particular data between the units such as distance data. The distance detection module determines the distance between units. By way of example, the distance detection module may generate a signal utilized by the central processor to calculate the distance between paired units.

In an embodiment, the transceiver units include one or more site units and one or more pet units. The site unit couples to a geographic site or facility within a control area. The pet unit is worn by a pet, e.g., via a pet collar. The site and pet units may be selectively paired such that a site unit activates a stimulus on the collar unit when a predetermined threshold distance is measured by the central processor via the distance detection module. In operation, a first pet unit may be unpaired with a first site unit to permit a first pet access to the site, while a second pet unit may be paired with the site unit to deny a second pet access to the site.

### BRIEF DESCRIPTION OF THE DRAWINGS

FIG. 1 illustrates a block diagram of the electronic pet containment system in accordance with an embodiment of the invention.

FIG. 2 is a block diagram of transceiver unit in accordance with an embodiment of the invention, showing a radio frequency (RF) communication transceiver module.

FIG. 3 is a block diagram of a transceiver unit in accordance with an embodiment of the invention, showing a Bluetooth® communication transceiver module.

FIG. 4 is a block diagram of a transceiver unit in accordance with an embodiment of the invention, showing optional input devices.

FIG. 5 is flow chart illustrating the operation of the device of FIG. 2 in accordance with an embodiment of the invention.

FIG. 6 is flow chart illustrating the operation of the device of FIG. 3 in accordance with another embodiment of the invention

FIG. 7 illustrates the operation of the pet containment system, showing a pet transceiver unit coupled to pet and a site unit coupled to a site within a control area.

FIG. 8A illustrates a perspective view of a transceiver unit in accordance with an embodiment of the invention.

FIG. 8B illustrates a perspective view of a collar/pet unit in accordance with an embodiment of the invention.

FIG. 9 illustrates a block diagram of a pet containment system in accordance with another embodiment of the invention.

FIGS. 10A and 10B illustrate the graphic user interface displayed on the display device of FIG. 9.

Like reference numerals have been used to identify like elements throughout this disclosure.

### DETAILED DESCRIPTION OF THE INVENTION

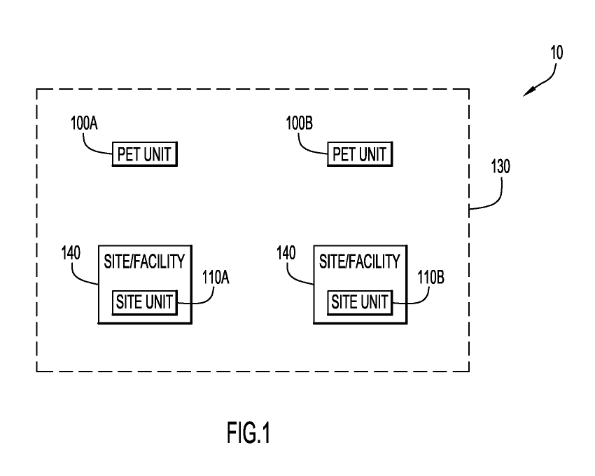

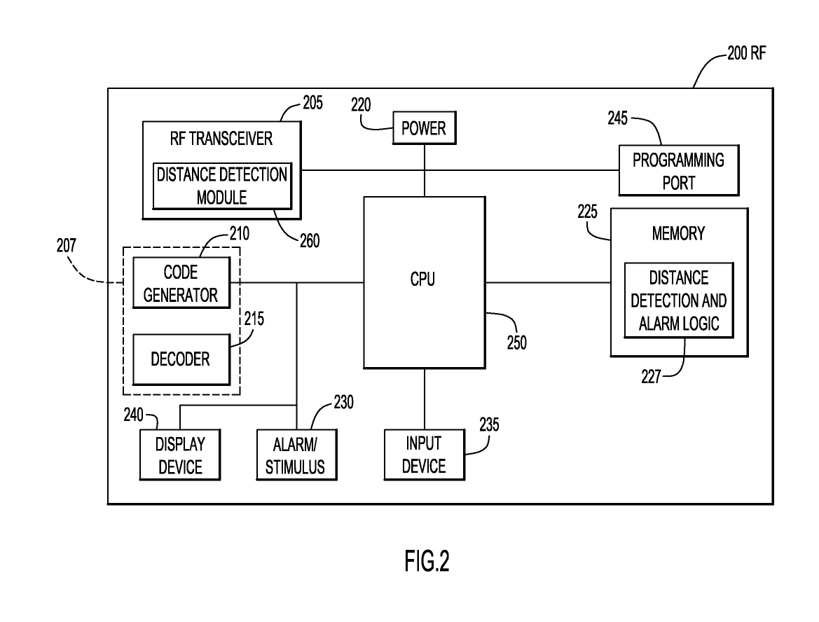

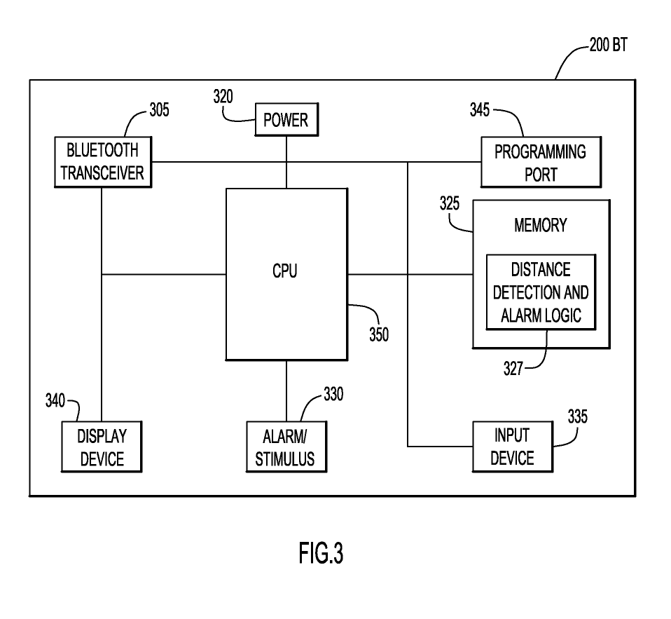

FIG. 1 illustrates an electronic pet containment system in accordance with an embodiment of the invention. As shown, the system 10 includes a plurality of transceiver units 200 (FIGS. 2 and 3) designated to function as either a pet unit 100A, 100B or a site unit 110A, 110B. The system 10 may be utilized within a control area 130 including one or more access-sensitive sites/facilities 140. The pet unit 100A, 100B is secured to a pet (not shown) contained within the control area 130. By way of example, the pet unit 100A, 100B may be affixed to the collar of a pet. It should be understood, however, that the pet units 100A, 100B may be attached to one or more of a plurality of pets by any conventional securing method (straps, etc.). The site unit 110A, 110B is secured to a corresponding site 140 within the control area 130. By way of example, the control area 130 may be a house, apartment, or yard, and the site 140 may be any object to which pet access is selectively granted such as furniture pieces, feeding containers, litter boxes, etc. The site unit 110A, 110B may be affixed to a site 140 utilizing, e.g., straps, pressure sensitive adhesive, tape, etc.

The transceiver units 200 are configured to communicate with each other, selectively transferring data between the units. The units may further be configured to apply stimulus when a predetermined reference parameter is detected between communicating units. FIG. 2 illustrates an electronic block diagram for a transceiver unit 200 including a standard radio frequency (RF) communication protocol. In general, the RF transceiver unit 200RF includes a radio frequency (RF) transceiver module 205, a pairing module 207 including a code generator (or encoder) 210 and a decoder 215, a power source 220, memory 225, and a stimulus device or alarm 230. The transceiver module 205 is a communications module operable to continuously communicate with other modules, wirelessly transferring (sending and receiving) data signals to/from other transceiver modules within the system 10 (e.g., identification information). The transceiver module 205 may further include a distance detection module 260 operable to generate signals utilized to calculate a measured distance between electronically paired units (explained in greater detail below).

The power source 220 may include a storage source such as a battery. The memory 225 may be random access memory (RAM) or read only memory (ROM) capable of assigning, recording, and programming the transceiver units 200, as well as capable of data storage. By way of example, the memory 225 may be programmed to store all necessary data including pet IDs/site IDs, as well as the address of the transceiver unit 200RF (thus, each pet and each site 140 may have a unique identifier that is stored in the transceiver unit 200RF). The memory 225 may also store programming logic 227 (e.g., programmable distance detection and alarm logic) that enables CPU 250 to calculate/measure the distance between communicating transceiver units 200RF utilizing information received from the transceiver module 205 and/or the distance detection module, as well as enables the CPU to trigger the stimulus device 230 on the transceiver unit 200RF.

The stimulus device 230 may include, but is not limited to, audio alarms, illumination alarms, vibration units, and/or electrical discharge units. The transceiver unit 200RF may further include one or more input devices 235 for entering operational parameters of the unit, as well as one or more display devices 240 to display information relating to the operation of the unit (each described in greater detail below). In an embodiment, the transceiver unit 200RF further includes an optional programming port 245 to enable connection of the transceiver unit to a third party device such as a personal computer, a mobile phone, etc. By way of example, the programming port 245 may comprise a mini USB hub or an IR port. Each of the above-described components 205, 210, 215, 220, 225, 230, 235, 240, 245, 260 may be electronically coupled and in communication with a central processing unit (CPU) 250. The CPU 250 enables communication between the various components 205, 210, 215, 220, 230, 235, 240, 245, 260, as well as controls the various components to effectuate operation of the device.

The pairing module 207 identifies and selectively pairs (electronically links) transceiver units 200RF to permit transfer of specified data between units via the transceiver module 205. By way of example, the pairing module 207 may enable transfer of distance detection data (e.g., signals generated by the distance detection module 260). In the illustrated embodiment, the pairing module 207 includes an encoder 210 and decoder 215. The encoder-decoder cooperates to assign and identify a unique identifier to each transceiver unit 200RF. In an embodiment, the paring module 207 includes RF/IR encoder/decoder chip sets. In other embodiments, the pairing module 207 includes an ultrasonic encoder-decoder and/or a wireless encoder-decoder. In operation, the CPU 250 operates the encoder 210 to assign a unique identifier to a first transceiver. This unique identifier may be decoded by the decoder 215 of a second transceiver unit. If the decoder 215 of the second transceiver unit is capable of decoding the unique identifier sent by the encoder 210 of the first transceiver unit, the units are electronically paired. Once paired, the transceiver module 205 sends and receives modulated data over a frequency unique to the units, enabling the CPU 250 to initiate and maintain communication with corresponding (paired) units. In another embodiment, the pairing module is configured to set units to identical frequencies (utilizing logic 227 contained in memory 225) to pair the units.

With the above configuration, a first plurality of transceiver units 200RF may be categorized as pet units 100A, 100B, each being assigned a pet ID, while a second plurality of transceiver units 200RF may be categorized as site units 110A, 110B, each being assigned a site ID. One or more of the plurality of pet units 100A, 100B may then be electronically paired to one or more of the plurality of site units 110A, 110B (and vice versa) and/or to one or more of the other pet units, enabling communication of data between the units.

The transceiver units 200RF are further programmed to monitor (e.g., measure or calculate) the distance between paired units, as well as to activate the stimulus device 230 on one or both of the units when the measured distance between the units crosses a threshold or reference distance. The transceiver module 205 may further include a distance detection module 260 operable to generate a signal utilized by the CPU 250 to calculate the distance between paired units. In one embodiment, the distance detection module 260 generates an aerial digital output current (DOC) (i.e., an analog value that is transforms into a digital command sent to the CPU). The value (strength) of the DOC may be inversely proportional to the distance between paired units. By way of example, the value of the DOC may increase with decreasing distance between communicating units (e.g., between a pet unit 100A and its paired site unit 110A). The programming logic 227, moreover, may include definitions correlating specified measured DOC values with predetermined distance values. As a result, as a pet unit 100A, 100B approaches a paired site unit 110A, 110B, for example, the DOC value will equal one of the specified values, indicating the distance between the transceiver units. In an embodiment, the DOC signal is embedded within the RF data generated by the transceiver module such that the CPU 250 extracts information from the aerial DOC of the modulated RF data to determine the distance between units.

In still other embodiments, the distance detection module 260 is an infrared device, an ultrasonic device, a global positioning system (GPS) device, and or any device capable of generating a signal utilized by the CPU 250 to determine the distance between paired transceiver units 200RF.

The calculated/measured distance value D is then compared to a reference or threshold distance value R_{d} that defines the pet restricted area (PRA), i.e., the area surrounding a site 130 into which a pet is prohibited from entering. Each transceiver unit 200RF may be programmed with a reference value R_{d} entered, e.g., by a user; consequently, each pet unit 100A, 100B and/or site unit 110A, 110B may have a PRA associated with it. By way of example, if the reference distance R_{d} of a transceiver is six (6) feet, the PRA would include all areas within a six (6) foot radius of the transceiver. The CPU 250 compares the measured distance D with the reference distance R_{d} to determine whether or not activation is the stimulus device 230 is required.

By way of example, a pet unit 100A, 100B measures the distance between it and a site unit 110A, 110B with which it is paired (as described above). When the measured distance D becomes less than and/or equal to the reference distance R_{d}, the CPU 250 determines that the pet unit 100A, 100B has entered the PRA and activates the stimulus device 230 on the pet unit 100A, 100B, on the site unit 110A, 110A, or both. If the stimulus device 230 is a vibration device, then the vibration device on the pet unit 100A, 100B and/or the site unit 110A, 110B is activated. Alternatively, the paired pet unit 100A, 100B and site unit 110A, 110B may be programmed such that, when the pet unit 100A enters the PRA, different stimulus devices 230 are activated. By way of example, the pet unit 100A, 100B may activate the vibration device, while the site unit 110A, 110B may activate an audible alarm.

FIG. 3 is an electrical schematic of an embodiment for a transceiver unit 200 including a RF transceiver utilizing Bluetooth® communication protocols. As shown, the transceiver unit 200BT includes a Bluetooth® transceiver module 305, a power source 320, memory 325, a stimulus device or alarm 330, one or more input devices 335, one or more display devices 340, and an optional programming port 345 electronically coupled and in communication with a CPU 350. In this embodiment, the transceiver module 305 is configured to communicate data with other transceiver modules within the system 10, as well as to generate signals utilized to indicate the distance between communicating units. In addition, the power source 320 may be a power storage device such as a battery.

The memory 325 may be random access memory (RAM) or read only memory (ROM) utilized for assigning, recording, and programming of the transceiver module 305, as well as for data storage (e.g., for storing the address of the transceiver unit). The memory 325 may also store programming logic 327 (e.g., programmable distance detection and alarm logic) that enables the CPU 350 to calculate the distance existing between paired transceiver units 200BT and/or to trigger the stimulus device 330. The memory 325 may also be programmed to store all necessary data including pet IDs, site IDs, etc. (thus, each pet unit 100A, 100B and each site unit 110A, 110B may have unique identifier that is stored in the memory).

The central processing unit (CPU) 350 enables communication between the various components 305, 320, 325, 330, 335, 340, 345, controlling the components to effectuate operation of the device. The input device 335 and the display devices 340 are similar to those of the RF transceiver configuration (and are described in greater detail below).

Each transceiver unit 200BT includes a unique identifier or address provided via the Bluetooth® communication protocol. Addresses may be paired to enable data transfer between units occurs via signal exchanges. In an embodiment, each transceiver unit 200BT includes a single transceiver module 305 operable to communicate with the single transceiver module contained another transceiver unit. In another embodiment, a plurality of transceiver units 200BT forms a piconet with transceiver modules 305, selectively communicating with each other (i.e., a single transceiver unit may communicate with a plurality of other transceiver units). Since each transceiver unit 200BT includes a unique address under Bluetooth® communication protocol, there is no need to encode or decode identifiers that are associated with each paired unit, as occurs in general RF transceiver unit described above (FIG. 2).

The transceiver module 305 further generates a signal utilized by the CPU 350 to calculate the distance D between transceiver units 200BT. In one embodiment, the CPU 350 continuously monitors the strength of Bluetooth® signals exchanged between paired transceiver units (e.g., between a pet unit 100A, 100B and its paired site unit 110A, 110B). By way of example, the strength of the signal generated by the transceiver module 305 may be generally proportional to the distance between paired transceiver units 200BT, with signal strength increasing with shorter distances. The CPU 350 may be programmed to associate specified signal strength values with predetermined distance values. Thus, when the signal strength generated by the transceiver module 305 reaches a specified value, the CPU 350 is able to determine the distance D between units, correlating the distance to the measured signal strength. In another embodiment, the transceiver module 305 includes a distance detection module (similar to that described above) configured to generate a non-Bluetooth® radio frequency (RF) signal (i.e., a frequency falling outside of the Bluetooth® frequency range), the strength of which is utilized by the CPU 350 to calculate the distance between paired units 200BT. As with the Bluetooth® signals, the non-Bluetooth® RF signal between a pet unit 100A, 100B and site unit 110A, 110B varies in proportion to the distance between the units. Thus, the RF signal strength may become stronger as the distance between the units decreases.

In still other embodiments, the distance detection module is an infrared device, an ultrasonic device, an RFDOC device, a global positioning system (GPS) device, a radar device and/or any device capable of generating a signal utilized by the CPU 350 to determine the distance between paired transceiver units 200BT.

In operation, the CPU 350 then compares the measured distance value D to the reference or threshold distance value R_{d} representing the PRA as described above. The CPU 350 is configured to activate the stimulus device 330 on one or both of the paired units whenever the measured distance is equal to and/or less than the reference distance D, again as described above.

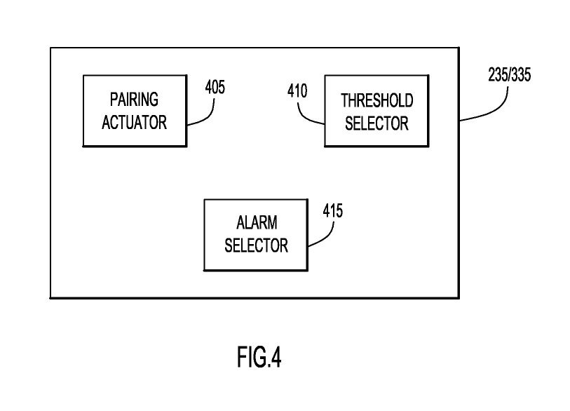

The input device 235, 335 for the transceiver units 200 may include one or more actuators that engage the programming logic to define various operational parameters of the transceiver units 200. By way of example, the input devices 235, 335 may be utilized to enter unit identifier/address information, to electronically pair transceiver units 200, to enter the reference distance value, and/or to enter the stimulus type. Referring to the embodiment shown in FIG. 4, the input device 235, 335 includes a pairing actuator 405 that activates the pairing protocol to electronically pair one transceiver unit 200 (e.g., a specified pet unit 100A) with another transceiver unit 200 (e.g., a specified site unit 110A) to enable communication and distance measurement between the units. By way of example, the keypad may be a numeric keypad. In one embodiment, to pair the transceiver units 200, the operator (pet owner) could engage the same keypad number on the transceiver units for a predetermined period of time (e.g., a few seconds). Successful pairing could be indicated via display devices 240, 340. For example, an LED may flash to indicate pairing of the units was successfully accomplished. This process is repeatable and pet owner could pair, unpair, assign, reassign, interchange, add, reduce, and reprogram transceiver units 200 within the system 10 as needed.

The input device 235, 335, may further include a threshold selector 410 that enters into the programming logic 227, 327 the reference distance value R_{d} utilized by the CPU to activate the stimulus device 230, 330. By way of specific example, the threshold selector 410 may be a keypad including specified threshold distance values (e.g., 2 feet, 4 feet, 6 feet) that designate the PRA of the unit 200 (e.g., the reference distance R_{d} at which the stimulus device is activated). Specifically, when the distance D between the paired 200 units is less than the reference distance value R_{d}, the stimulus device 230, 330 may be activated on either or both of the paired units.

In addition, the input device 235, 335 may include a stimulus/alarm selector 415 utilized to enter into the programming logic 227, 327 the type of stimulus device 230, 330 that is to be activated when the PRA has been breached. For example, the stimulus/alarm selector 415 may be a keypad including predetermined stimulus options used to designate the active stimulus device 230, 330 (e.g., audio, electrical stimulus, etc.). It should be understood that the input devices 235, 335 are not limited to that disclosed herein, and that the pet unit may include more or less input devices, depending on the functionality desired.

The display devices 240, 340 indicate the status of various operational parameters of the transceiver unit 200. For example, the display device 240, 340 may include one or more LEDs that indicate the active stimulus mode (e.g., vibration, shock, alarm (visual (e.g., light) or audio)), the operational status of the transceiver unit 200 (active/inactive, ON/OFF, paired/unpaired), power levels for batteries operating the unit, and the successful pairing of units as described above. It should be understood that the display devices 240, 340 are not limited to that disclosed herein, and that the transceiver units 200 may include more or less display devices, depending on the functionality desired.

In operation, a transceiver unit 200 is assigned to either a pet (becoming a pet unit 100A, 100B) or to a site 140 within the control area 130 (becoming a site unit 110A, 110B). For example, an operator may secure a transceiver unit 200 to a pet and/or enter a pet ID to categorize the transceiver unit as a pet unit. Similarly, the operator may secure a transceiver unit 200 to a site 140 and/or enter a site ID to categorize the transceiver unit as a site unit. The pairing actuators 405 on a pet unit and a site unit may then be engaged to initiate the pairing protocol (as described above). The threshold selector 410 on one or both of the units is then engaged to enter the reference distance R_{d}, thereby defining the PRA at which the stimulus device 230, 330 on one or both of the units will activate. The stimulus selector 415 may then be engaged on one or both of the units to designate the desired alarm output. Finally, the pairing buttons 405 on the units may be engaged again to finalize the pairing protocol and save the selections to the memory 225, 325.

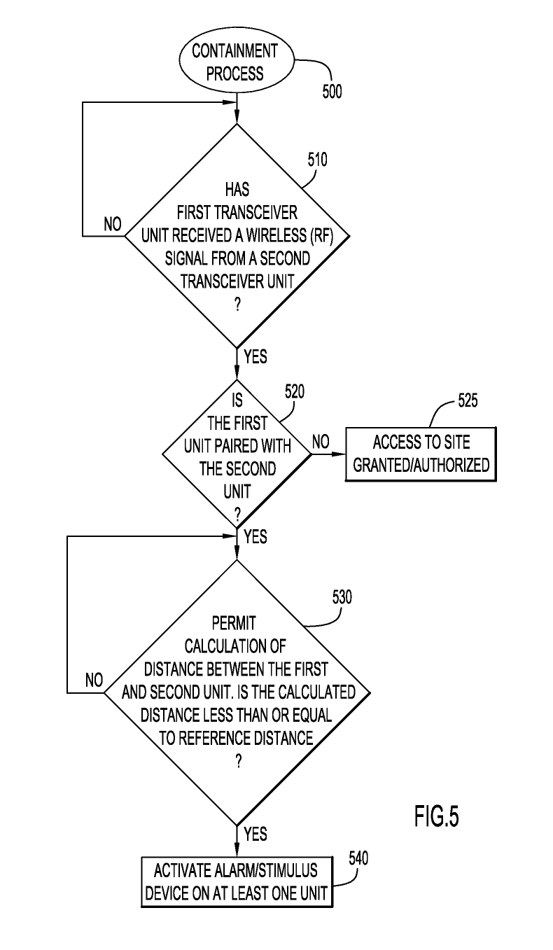

The operation of pet containment system including a plurality of RF transceiver units 200RF is explained in further detail with reference to FIG. 5. The process is initiated at Step 500 by activating the transceiver units 200RF within the system and assigning the units to either a pet or a site as described above. Once assigned, at Step 510, the programming logic 227 directs the CPU 250 to determine whether RF signals from other units are being received by the transceiver module 205. By way of specific example, a pet unit 100A, 100B determines whether or not it is receiving an RF signal from any of the site units 110A, 110B contained within the system 10.

If an RF signal is received, at Step 520 the programming logic 227 determines whether the pet unit 100A, 100B is paired with any of the site units from which the signal is received. As described above, the pet units 100A, 100B may receive modulated, encoded data contained within an RF signal received from the various site units 110A, 110B (and vice versa). If the pet unit 100A, 100B is able to decode the data contained within the received RF signal, then the pet unit determines that it is paired with that site unit. Upon decoding the modulated data, the pet unit 100A, 100B may send a response signal to the site unit 110A, 110B indicating that the pet unit is able to decode such data, confirming the pairing. If the pet unit 100A, 100B determines that it is not paired with a site unit 110A, 110B, then at Step 525, the pet unit is “granted access” to the site 140, being permitted to approach the site unit 110A, 110B without triggering activation of the stimulus device 230 regardless of distance between the units. If, however, the pet unit 100A, 100B is paired with the site unit 110A, 110B, the distance detection signal generated by the distance detection module 260 is transferred between the units, and the CPU 250 (in connection with programming logic 227) the determines the distance D between the pet unit 100A, 100B and its paired site unit 110A, 110B as described above, continuously comparing the measured distance D to the reference distance R_{d}.

Should the CPU 250 determine the distance between the pet unit 100A, 100B and its paired site unit 110A, 110B is less than and/or equal to the reference distance R_{d}, at Step 540, the stimulus device 230 on one or both of the transceiver units is activated by the CPU to indicate that one of the units (the pet unit 100A, 100B or site unit 110A, 110B) is within the PRA of the another unit. If, however, the distance D between the pet unit 100A, 100B and the site unit 110A, 110B is greater than the reference distance R_{d}, the CPU 250 continues to monitor the distance between the pet unit 100A, 100B and the site unit 110A, 110B with which it is paired, continuously comparing the measured distance D to the reference distance R_{d}. A process similar to the one just described also occurs between paired pet units.

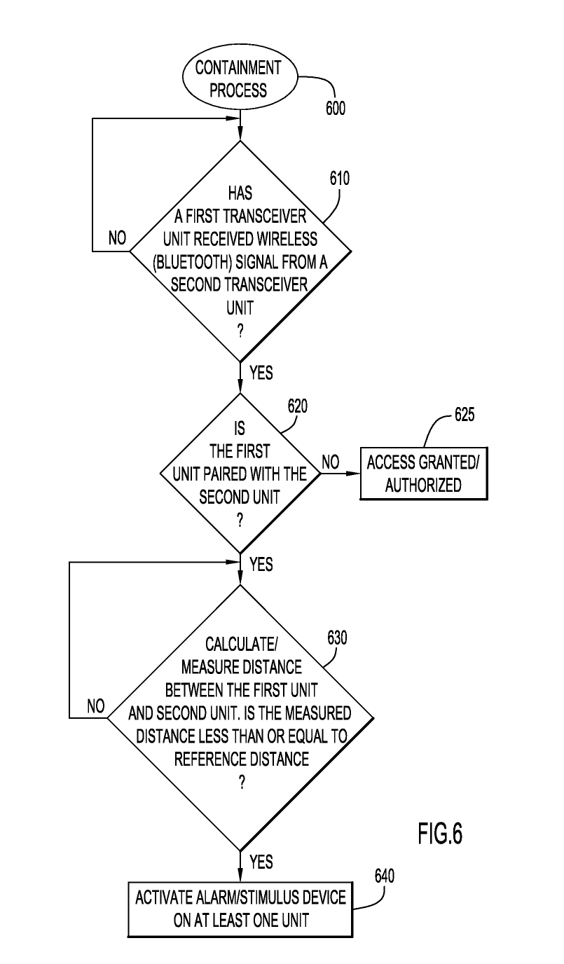

The operation of a Bluetooth® transceiver unit 200BT is explained in further detail with reference to FIG. 6. At Step 600, the process is initiated when transceiver units 200BT are activated and assigned to either a pet or a site 140 as described above. At Step 610, the transceiver units 200BT discover any other transceiver units 200BT within the system 10. By way of specific example, the pet unit 100A, 100B determines whether it has received a signal from one or more site units 110A, 110B. If the pet unit 100A, 100B receives a signal from a site unit 110A, 110B, the CPU 350, at Step 620, determines whether the pet unit 100A, 100B is paired with the site unit 110A, 110B. As described above, the transceiver modules 305 initiate and maintain Bluetooth® signal exchange sessions to transmit unique identifiers that identify transceiver units 200BT as being electronically paired units operable to exchange data.

If the pet unit 100A, 100B is not paired with the site unit 110A, 110B, then the pet unit 100A is “granted access” at Step 625, permitting the pet unit to enter the PRA and, as such, permitting the pet to access the site 140 without alarm activation. If, however, the pet unit 100A, 100B is paired with the site unit 110A, 110B, then at Step 630, distance detection data is further transferred between the units, and the CPU 350 (in connection with programming logic 327) continuously monitors the distance D between the paired units as described above. The CPU 350 compares the measured distance D with the reference distance R_{d}. If the measured distance D is less than and/or equal to the reference distance R_{d}, the CPU 350 of the units 100A, 100B, 110A, 110B may, at Step 640, activate the respective stimulus device 330 on one or more of the units to indicate that one of the units is within the PRA of the other unit. If, however, the measured distance D between paired units 100A, 100B, 110A, 110B is greater than the reference distance R_{d}, the CPU 350 continues to monitor the measured distance D between the paired units, continuously comparing the measured distance to the reference distance R_{d}. A process similar to that described above also occurs between paired pet units.

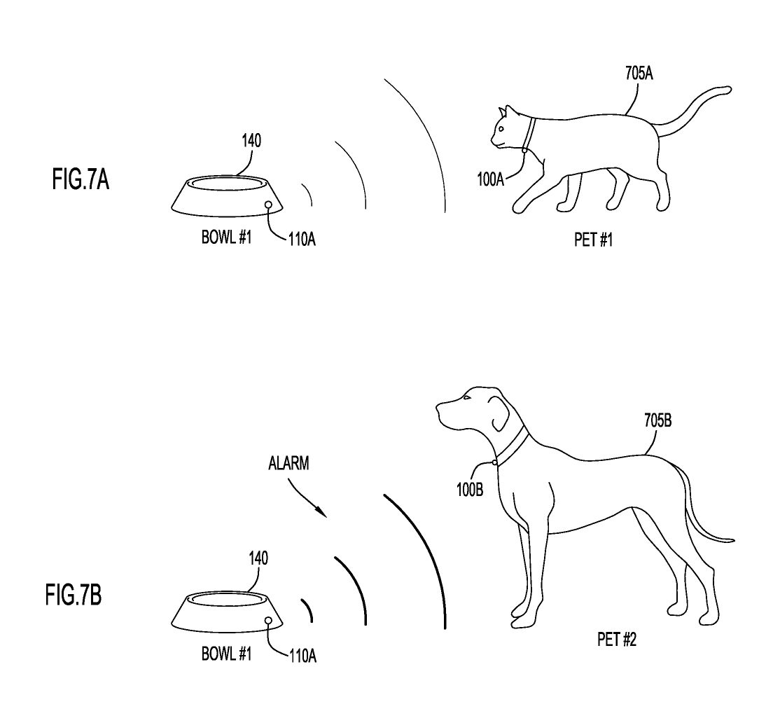

FIGS. 7A and 7B illustrate the operation of the pet containment system in accordance with an embodiment of the invention. Referring to FIG. 7A, a first transceiver unit 200 is assigned to a first pet 705A, thereby becoming a first pet unit 100A. A second transceiver unit 200 is assigned to a site 140 (e.g., a feeding bowl), thereby becoming a site unit 110A. In this example, the pet unit 100A is not paired with site unit 110A. Accordingly, the pet 705A is able to approach the site 140 without the first pet unit 100A or the site unit 110A triggering the stimulus device 230, 330.

Referring to FIG. 7B, a third transceiver unit 200 is assigned to a second pet 705B, becoming a second pet unit 100B. The site unit 110A, as above, is coupled to the site 140. In this example, the second pet unit 100B is electronically paired with site unit 110B. Accordingly, when the measured distance D between the second pet 705B and the site 140 is less than or equal to the reference distance R_{d}, the stimulus device 230, 330 on the second pet unit 100B is activated to indicate that the second pet 705B is within the PRA of the site unit 110A, as well as encouraging the second pet to leave the restricted area.

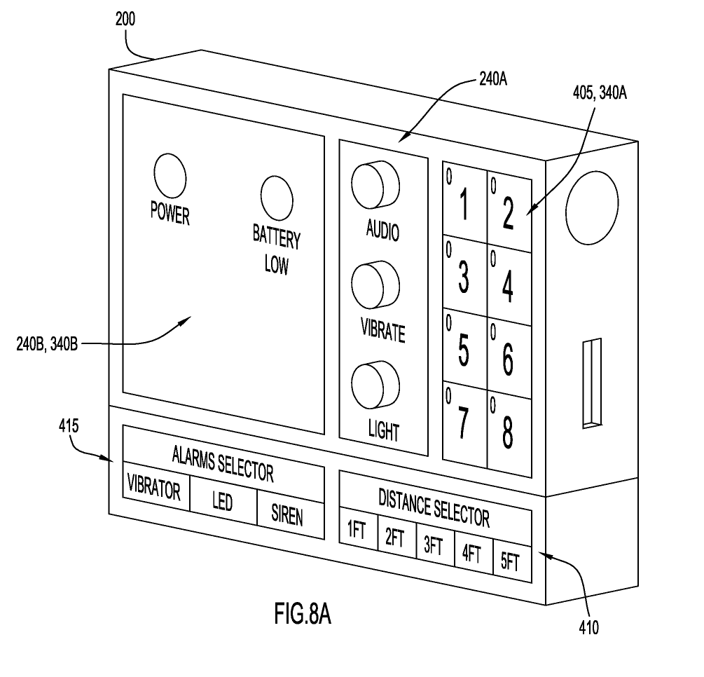

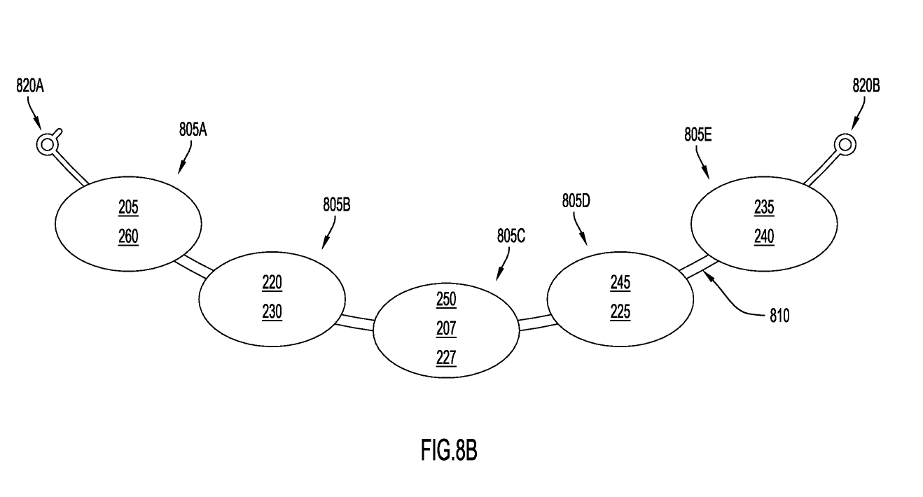

FIG. 8A is a perspective view of a transceiver unit 200 in accordance with an embodiment of the invention. As shown, the transceiver unit 200 includes a first display device 240A, 340A with a series of LEDs indicating, e.g., the operative stimulus mode (e.g., vibration, shock, alarm (visual (e.g., light) or audio) and a second display device 240B, 340B including LEDs indicating whether the device is powered and/or whether the battery needs to be replaced. The transceiver unit 200 may further include one or more input devices 235, 335. As shown, the transceiver unit 200 includes the pairing actuator 405, the distance selector 410 to enable selection of the activation distance of the unit 200, and the stimulus selector 415 to enable selection of the stimulus output of the transceiver unit 200. By way of specific example, each input device 405, 410, 415 may be a keypad with depressible buttons.

FIG. 8B illustrates a transceiver unit in accordance with another embodiment of the invention. As shown, each of the components 205, 207, 220, 225, 227, 230, 235, 240, 245, 250, and 260 of the transceiver unit 200RT are disposed within a series of housings 805A, 805B, 805C, 805D, 805E. The components, moreover, connected via a communications conduit such as integrated drive electronics (IDE) cable 810. The IDE cable may further include a latch portions 820A, 820B that latch together to secure the transceiver unit 200RT to the pet or site. The Bluetooth® transceiver unit 200BT may have a similar configuration.

Thus, the above described embodiments provide an electronic containment system including a series of transmitter/receiver (transceiver) units that are selectively paired to permit a desired level of access to sites within a control area. The transceiver units include a central processor, a communications or transceiver module and a distance detection module. The communications module of each transceiver unit communicates with (e.g., transfers data between) other transceiver units within the system. The central processor of one transceiver unit utilizes the transferred data to identify the other units within the system. The distance detection module may generate a signal utilized by the central processor to calculate the distance between units.

A first transceiver unit may be selectively paired with a second transceiver unit. That is, the first in second transceiver units operate in a first, unpaired electronic mode, in which a first level or amount of data is transferred between the units, and a second, paired electronic mode, in which a second level or amount of data is transferred between the units. In the unpaired state, the first level of data includes unit identification information and/or whether or not the units are paired or unpaired. In the paired stated, second level of data may include additional information such as the measured distance and/or instructions to activate the stimulus device.

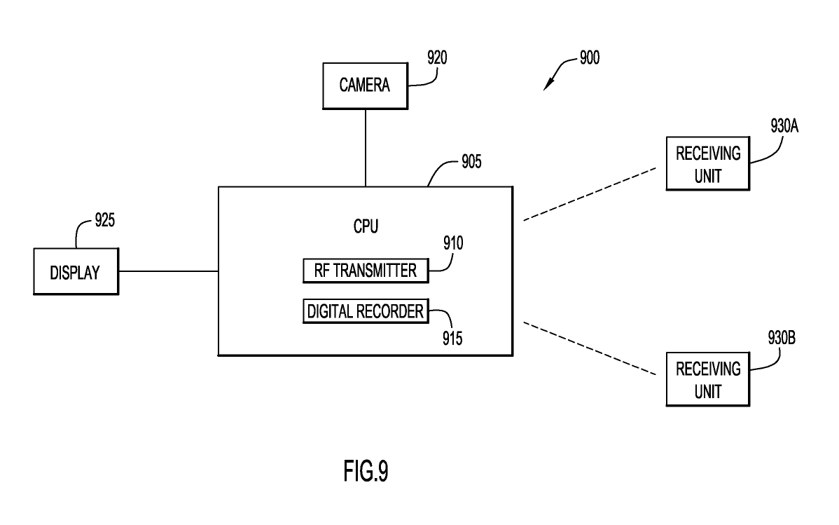

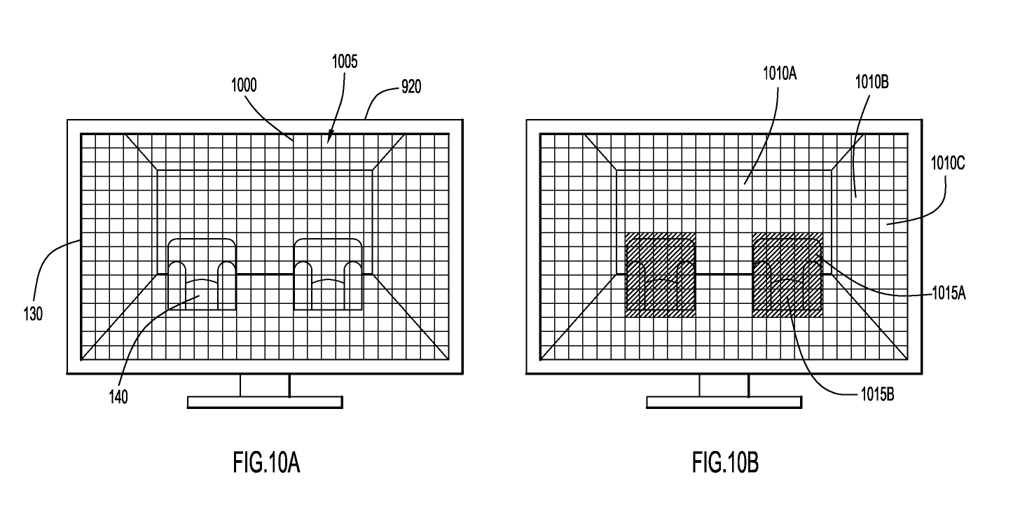

FIG. 9 illustrates a pet containment system in accordance with another embodiment of the invention. As illustrated, the system 900 includes a central processing unit 905 with a transmitter device 910 and a DVR unit 915 therein. The CPU 905 is in communication with one or more video cameras 920, as well as a display device 925. The system 900 further includes one or more receiver units 930A, 930B that receive wireless signals sent by the transmitter device 910 contained in the CPU 905. The video camera 920 sends an image to the CPU 905, which displays the image on the display device 925. By way of example, the display device 925 may be a monitor. The CPU 905 runs software operable to generate a graphic user interface over the image displayed on the display device 910. Referring to FIG. 10A, the software may generate a grid pattern 1000 over the displayed image 1005. The grid pattern 1000 may be a series of generally square panels 1010A, 1010B, 1010C arranged in both the X and Y directions on the screen.

The software may further be configured such that various panels within the grid may be highlighted to generate active panels 1015A, 1015B within the grid pattern 1000 (FIG. 10B). The software functions such that, if an object moving across the displayed image 1005 intersects an activated panel 1015A, 1015B, the CPU 905 generates a signal that is transmitted (via the transmitter unit) to one or more of the receiver units.

In operation, a user positions the camera 920 within a control area 130 such that one or more restricted sites 140 are within camera view and the restricted sites are displayed on display 925. The user connects a receiver unit 930A, 930B to a pet. The software is utilized to generate the grid pattern 1000 over the displayed image. A user activates panels 1015A, 1015B within the grid 1000 that correspond to the restricted sites 140 within the displayed control area 130 (as described above). Should a pet wearing a receiver unit 930A, 930B enter an area of the location viewed by the camera 920 such that it enters an activated panel 1015A, 1015B selected via the software, the software directs the transmitter 910 to send a signal to the receiver unit 930A, 930B coupled to the pet. The signal activates the stimulus device on the receiver unit 930A, 930B, generating the appropriate stimulus (audio, electrical, vibration, etc.), thereby signaling to the pet that a restricted site has been entered, keeping the pet away from the selected area.

The above described systems provide an effective way to restrict access to pets to desired facilities/sites within a control area (e.g. a home). Many households today accommodate multiple pets and, as such, face problems with one pet interfering with the facilities (food/water bowl, litter box, sleeping area) of another pet. The present system enables the pet owners to prevent such interference, thereby helping the owners manage their pets so that each pet would have access only to predefined, sanctioned facilities and would be stopped from approaching other predefined, non-sanctioned facilities by the activation of and alarm on one or both of the pet unit or the site unit. This invention solves the problem outlined above by using paired devices on each pet and its facilities. The site units (typically associated with a site such as the pet's bowl, permitted areas, etc.) and pet unit (e.g., a collar nit, typically attached to the pet's collar or necklace) are programmed to recognize each other in the household and only allow the authorized pet that to approach said facilities. The units are programmable by the pets' owner in a way that all of them could be flexibly coded in the coder/decoder cell. The owner, moreover, is able to reduce, add, pair, un-pair, and interchange the units accordingly. Alarms may be triggered on one or both of the pet unit and site unit to prevent unauthorized pets using other pets' facilities.

While the invention has been described in detail and with reference to specific embodiments thereof, it will be apparent to one skilled in the art that various changes and modifications can be made therein without departing from the spirit and scope thereof. For example, while the system is disclosed as being utilized with household pets, it may be further utilized with farm animals and zoo animals. In addition, the system 10 may be utilized with humans to enable monitoring of movement within a location. In addition, while system has been described such that paired units selectively activate the stimulus device, the system may be configured such that unpaired units may selectively activate the stimulus device (i.e., enable distance detection and stimulus activation protocols), while paired units by default would not activate the stimulus device (granting a pet access to a site or another pet).

In addition, while the exemplary mode of operation has shown limiting the distance between a pet and a site, it should be understood that system may be configured to limit the access of one pet with respect to another pet. That is, multiple transceiver units 200 assigned to pets may be paired to create a PRA for one pet with respect to another pet.

Each of the above systems may include a time/day parameter, in which the user programs the activation/deactivation of the device based on the time and/or day. In addition, the paired site/collar transceiver units may be programmed such that only one unit governs (i.e., a master/slave communication protocol may be utilized). This is helpful should each device be programmed with differing parameters. For example, should a user set a first distance on the site unit, but a second, conflicting distance on the pet unit, the system may be configured to permit one unit to control (e.g., the unit having the shorter distance or simply the distance indicated on the site unit). The site units, moreover, may be programmed with a default mode that activates the alarm unless the pet unit is specifically paired with that site unit.

In addition, the transceiver units 200 may include any number of display devices, including an LCD display. Any number and types of input devices may be utilized. The alarms may include, but are not limited to, siren, light, vibration, and electrical stimulus (e.g., a gentle electrical shock via the collar). The alarms may include, but are not limited to, siren, light, vibration, and electrical stimulus.

Each transceiver unit 200 (pet units 100A, 100B and site units 110A, 110B) may contain one or more of a communications/transceiver module, a CPU, memory (e.g., random access memory (RAM)), power source (e.g., battery), a pairing module, a display device, alarm, an input device, and a programmable port module. The pet owner may select the suitable stimulus protocols via programming the CPU. The input device may include keypad figures that vary for different applications. The possibility of remote programming (through wireless networks) is always applicable.

The transceiver module may include any pairing module 207 and/or distance detection module 260 suitable for its described purpose. In addition, any suitable combination of these modules may be utilized. For example, the pairing module may be any suitable encoder/decoder chipsets such as an infrared encoder-decoder unit (Microchip MCP2120 (available from Microchip Technology Inc.)). The distance detection module, moreover, may include any wireless communication formats such as RF (including Bluetooth®) modules, ultrasonic modules, IR modules, and/or GPS modules. By way of further example, the distance detection module may be any signal strength comparing device suitable to detect the proximity of one device to another.

In an embodiment, an RF-ultrasonic transceiver module or a Bluetooth® transceiver module may be utilized to serve as the pairing module and an infrared, ultrasonic, GPS, RFDOC, or other wireless module could act as the distance detector for activating alarms on unauthorized pets. In another embodiment, the pairing module may include an integrated circuit such as Texas Instruments PAL chips, Radiometrix® chips (e.g., CTA88, available from Radiometrix Ltd.), etc. for encoding and decoding, while the distance detection module would be provided by setting certain aerial digital output currents (DOC) corresponding to desired pre-selected distances between the transceiver units installed on the pet and the unit. In a further embodiment, a wireless encoder-decoder unit would serve as the pairing module and an infrared, ultrasonic, GPS, RFDOC, or other wireless module would act as the distance detector for activating alarms on unauthorized pets.

In a still further embodiment, any of the previously described options could be utilized as the pairing module, while the distance detection module would include a laser module or a radar module for activating alarms on unauthorized pets. In another embodiment, laser and radar modules would serve for assigning IDs to the pets and units and for detecting the distance for activating alarms on unauthorized pets.

The present invention also relates to a method of containing a pet within a control area containing a site requiring restricted access. The steps of the method include: (a) assigning a first transceiver or site unit to a site requiring restricted access, (b) assigning a second transceiver unit or pet unit to the pet, (c) coupling the site unit to the site, and (d) coupling the pet unit to a pet. The pet unit may include a pet unit stimulus device, a pet unit transceiver module operable to measure a distance between the pet unit and the site unit to provide a measured distance, and a pet unit processor programmed to selectively activate the stimulus device. The pet unit is configured to operate in a first electronic mode, in which the pet unit is not electronically paired with the site unit, and in a second electronic mode, wherein the pet unit is electronically paired with the site unit. The method may further include activation of the pet stimulus device by the pet unit processor when the pet unit is paired with the site unit and the measured distance is equal to or less than a predetermined reference distance.

Thus, it is intended that the present invention covers the modifications and variations of this invention provided they come within the scope of the appended claims and their equivalents.

I claim:

1. An electronic pet containment system for selectively providing access to a site within a control area, the system comprising:
a site unit assigned to a site within the control area; and
a pet unit assigned to a pet, the pet unit including:
a pet unit stimulus device,
a pet unit transceiver module operable to generate a signal utilized to calculate a measured distance between the pet unit and the site unit, and
a pet unit processor programmed to selectively activate the pet unit stimulus device,
wherein the pet unit is configured to operate in a first electronic mode, in which the pet unit is not electronically paired with the site unit, and in a second electronic mode, wherein the pet unit is electronically paired with the site unit; and wherein the pet unit processor activates the pet unit stimulus device when: (a) the pet unit is paired with the site unit, and (b) the measured distance is equal to or less than a predetermined reference distance.

2. The electronic pet containment system of claim 1, wherein the pet unit processor does not activate the pet unit stimulus device when the pet unit is not electronically paired with the site unit regardless of the measured distance calculated.

3. The electronic pet containment system of claim 2, wherein the pet unit transceiver module is a radio frequency module.

4. The electronic pet containment system of claim 1, wherein the pet transceiver module is a Bluetooth module.

5. The electronic pet containment system of claim 3, wherein the site unit comprises:
a site unit stimulus device;
a site unit transceiver module operable to generate a signal utilized to calculate a measured distance between the site unit and the pet unit; and
a site unit processor operable to selectively activate the stimulus device,
wherein the processor further activates the pet unit stimulus device when the pet unit is paired with the site unit and a predetermined threshold distance is measured between the pet unit and site unit.

6. The electronic pet containment system of claim 5, wherein each of the pet unit stimulus device and the site unit stimulus device is selected from the group consisting of an audible alarm, a light source, a vibration device, and an electric shock device.

7. The electronic pet containment system of claim 1, wherein:
the pet unit comprises a first pet unit configured to couple to a first pet;
the system further comprises:
a second pet unit configured to couple to a second pet, the second pet unit including:
a second pet unit stimulus device,
a second pet unit transceiver module operable to generate a signal utilized to calculate a measured distance between the pet unit and the site unit, and
a second pet unit processor programmed to selectively activate the stimulus device; and
the second pet unit is configured to operate in a first electronic mode, in which the second pet unit is not electronically paired with the site unit, and in a second electronic mode, wherein the second pet unit is electronically paired with the site unit, and wherein the second pet unit processor activates the second pet unit stimulus device when (a) second pet unit is paired with the site unit and (b) a predetermined threshold distance is measured between the second pet unit and the site unit.

8. The electronic pet containment system of claim 1, wherein each pet unit is programmable with a unique identifier to enable recognition of the pet unit by the site unit, and vice versa.

9. The electronic pet containment system of claim 8, wherein each pet unit and each site unit further includes an encoder and a decoder to encode and decode the unique identifier, respectively.

10. The electronic pet containment system of claim 1, wherein at least one of the pet unit and the site unit comprises a distance detection module operable to generate the signal utilized to calculate the measured distance between the pet unit and the site unit.

11. The electronic pet containment system of claim 10, wherein the distance detection module is selected from the group consisting of an infrared module, an ultrasonic module, a GPS module, a radar module, and a radio frequency module.

12. The electronic pet containment system of claim 1, wherein:
each of the pet unit and the site unit includes a pairing module operable to electronically pair the pet unit to the site unit; and
the pairing module of each unit cooperates to transfer data between the units.

13. The electronic pet containment system of claim 13, wherein the pairing module is selected from the group consisting of an ultrasonic encoder-decoder, a wireless encoder-decoder, and an infrared encoder-decoder.

14. An electronic pet containment system for controlling access of a first pet to a second pet each located within a control area, the system comprising:
a first pet unit configured to couple to the first pet within the control area; and
a second pet unit configured to couple to a second pet within the control area,
wherein each pet unit includes:
a stimulus device,
a transceiver module operable to measure a distance between the first pet unit and the second pet unit to provide a measured pet distance, and
a processor programmed to selectively activate the stimulus device,
wherein the first pet unit is configured to operate in a first electronic mode, in which the first pet unit is not electronically paired with the second pet unit, and in a second electronic mode, wherein the first pet unit is electronically paired with the second pet unit; and wherein the first pet unit processor unit activates the first pet unit stimulus device when (a) the first pet unit is paired with the second pet unit and (b) the measured pet distance is equal to or less than a predetermined reference distance.

15. An electronic pet containment system for controlling access of pets to sites contained within a control area, the system comprising;
a first transceiver unit comprising:
a first processor,
a first stimulus device,
a first transceiver module operable to send and receive data, and
a first distance detection module operable to generate a distance detection signal; and
a second transceiver unit comprising:
a second processor,
a second stimulus device,
a second transceiver module operable to send data to and receive data from the first transceiver module, and
a second distance detection module operable to generate a distance detection signal,
wherein the first processor of the first transceiver unit utilizes the signal generated by the first distance detection module to calculate a measured distance between the first transceiver unit and the second transceiver unit, and wherein the first processor compares the measured distance to a threshold distance value to determine whether to activate the first stimulus device.

16. The electronic pet containment system of claim 15, wherein the first and second transceiver units each operates in a first electronic mode, in which a first amount of data is transferred between the first and second units, and in a second electronic mode, in which a second amount of data is transferred between the first and second units.

17. The electronic pet containment system of claim 16, wherein:
the first amount of data includes unit identification information; and
the second amount of data includes distance detection information.

18. The electronic pet containment system of claim 17, wherein:
each of the first and second transceiver units include a stimulus device; and
the second amount of data further includes instructions to activate the stimulus device in at least one of the first transceiver unit or the second transceiver unit.

19. The electronic pet containment system of claim 15, wherein each of the first transceiver unit and the second transceiver unit includes a pairing module operable to selectively electronically link the first transceiver unit to the second transceiver unit to permit transfer of additional data between the units.
